(19) United States
(12) Patent Application Publication
(10) Pub. No.: US 2010/0037718 A1
(43) Pub. Date: Feb. 18, 2010

(54) DUAL CLUTCH TRANSMISSION

(75) Inventor: Gerhard Gumpoltsberger, Friedrichshafen (DE)

Correspondence Address: DAVIS & BUJOLD, P.L.L.C., 112 PLEASANT STREET, CONCORD, NH, 03301, US

(73) Assignee: ZF FRIEDRICHSHAFEN AG, Friedrichshafen (DE)

(21) Appl. No.: 12/440,287

(22) PCT Filed: Sep. 3, 2007
(86) PCT No.: PCT/EP07/59181

§ 371 Date: Mar. 6, 2009

(30) Foreign Application Priority Data
Sep. 14, 2006 (DE) 102006043046.8

(51) Int. Cl. F16H 3/093

(52) U.S. Cl. 74/331

(57) ABSTRACT

A dual clutch transmission for a motor vehicle, having a dual clutch with two start up clutches which, via a prime mover, can be respectively connected with one of first and second transmission input shafts arranged coaxially in relation to each other, such that a group of gears is allocated to each of the transmission input shafts. To minimize the size of the transmission, the gear groups are constructed as sub-transmissions that are mounted laterally with respect to the dual clutch. Each gear group has a counter shaft and a main shaft, with the main shaft being a transmission output shaft. Each sub-transmission has a single sub-transmission connection that transmits drive from the associated transmission input shaft to the counter shaft of the sub-transmission.

This application is a National Stage completion of PCT/EP2007/059181 filed Sep. 3, 2007, which claims priority from German patent application serial No. 10 2006 043 046.8 filed Sep. 14, 2006.

### FIELD OF THE INVENTION

The invention concerns a dual clutch transmission.

### BACKGROUND OF THE INVENTION

Dual clutch transmissions are known as gearboxes for motor vehicles with gear shifts that are almost free from tractive force interruptions and have already proven themselves. Shifts free from tractive force interruptions avoid load shifts and speed breaks so that comfortable drivability and improved acceleration capacity are accomplished. In a current construction described in the category-defining DE 198 21 165 A1, a dual clutch constructed as two, for example, wet multidisk clutches, is provided with startup clutches that are respectively connected with a transmission input shaft. Both transmission input shafts are arranged coaxially in relation to each other, whereby the one transmission input shaft is constructed as a hollow shaft, in which the other input shaft is mounted as an internal central or solid shaft that emerges from the hollow shaft. Each input shaft is allocated the gearsets for a group of gears or gear steps, preferably the even gears of the one group and the odd gears of the other group. A reverse gear may be arranged in one or the other sub-transmissions depending on the number of gears.

Shifting via the input shafts takes place sequentially. In this process, the respective next gear is preselected in the transmission element not currently transferring torque, and the gear is shifted practically free from tractive force interruptions by the superimposed disengaging and engaging of both clutches. The change of the connection of the internal combustion motor from one transmission input shaft to the other transmission input shaft and therewith from the current gear to the next gear thus takes place practically without drive interruptions.

As a rule, dual clutch transmissions are constructed as automated transmissions in which the shifting processes are not started via the clutch pedal, but automatically via the driver's shift command with a shift selector lever or a rocker switch or via a shifting program and are implemented by a hydraulic and/or electrical control unit of the clutch and the respective shifting and synchronizing packages of the individual gears.

To increase the degree of efficiency and to reduce fuel consumption as well as toxic emissions of the internal combustion motors in motor vehicles, gearboxes, especially also dual clutch transmissions, are being increasingly designed with a higher number of gears, namely with six or even seven forward gears. Such transmissions have a relatively large overall length. The axial overall length of conventional dual clutch transmission results from stringing together the wet or dry dual clutch and the respective gear sets. Since dual clutch transmissions are primarily provided for front, crosswise installation, being installed in the motor compartment mostly between the internal combustion motor and a left wheel arch, the overall axial length is an important constructive feature of these transmissions. The overall installation space available in the motor compartment is already restricted by constructive and design specifications as well as by an increasing number and size of accessories, so that already contemporary six-gear dual clutch transmissions reach critical overall axial lengths, and the even longer seven-gear dual clutch transmissions with front, crosswise installation can hardly be accommodated in the specified installation space of the motor vehicle.

DE 103 05 241 A1 illustrates a six-gear or seven-gear transmission structure in which the gear groups are arranged on two countershafts axially parallel to the input shafts. In this case, loose wheels are pivoted on the countershafts while two fixed wheels are arranged on one of the two input shafts and at least one further fixed wheel is arranged on the other input shaft to drive two loose wheels in each case. This transmission structure has a comparatively slightly shorter overall length with six gears, and with seven gears the overall length is comparable to that of the category defining DE 198 21 164 A1.

The overall transmission axial lengths given in DE 103 05 241 A1 and DE 198 21 164 A1 can at best be slightly further shortened to a minor extent by optimizing the gearings, synchronizations or bearings. In order to additionally make accessible a significant potential for overall length shortening, other types of construction are necessary.

Another possible arrangement of the gear sets of a dual clutch transmission has been known from EP 1 455 116 A1. A first sub-transmission or gear group is mounted drivable from the hollow shaft via an idler or a chain drive and laterally alongside the clutch installation space. The solid shaft emerging from the hollow shaft carries several gearings and synchronizations of a second sub-transmission or of the other gear group. A comparable transmission arrangement has also been known from DE 10 2005 016 588 A1.

To be sure, further shortening of the overall axial length is attained in this way. The shortening attainable is nonetheless restricted by the relatively considerable length of the driving component of the solid shaft and is therefore rather too short for many applications.

Finally, DE 102 32 831 A1 illustrates a dual clutch transmission in a group construction. In this case, two sub-transmissions are arranged axially parallel in relation to a central drive shaft. The two sub-transmissions can be driven by the drive shaft via a fixed wheel. For this purpose, each sub-transmission has an input shaft with a clutch, the clutch being connected with a loose wheel which meshes with the fixed wheel of the drive shaft and can be coupled with the input shaft by engaging the clutch. The sub-transmissions are for their part subdivided into individual groups, whereby the structure of an elevated number of gears, for example a 12-gear transmission for commercial vehicles, can be realized.

The focal point of this document lies in the improvement of the synchronization, especially in reducing the inertial masses to be synchronized. For this purpose, several synchronization clutches are provided in the sub-transmissions. Furthermore, the two start up clutches of the sub-transmissions are respectively relied upon to synchronize the rotational speed of the input shaft and an allocated gearing, as a result of which they can be temporarily activated with a partial force.

This transmission structure indeed has a shortened overall axial length. The disadvantage with it is, however, that it uses two spatially separated clutches, resulting in increased construction expenditures and costs. Moreover, this entails an increased overall space requirement to accommodate the individual clutches as well as a higher weight. For a front, crosswise installation, especially for a six- or seven-gear vehicle with dual clutch transmission, this group mode of construction of the sub-transmissions in connection with dispensing with a compact dual clutch is therefore less advantageous.

### SUMMARY OF THE INVENTION

Against this background, the object of the present invention is creating a dual clutch transmission which has a design as compact as possible, above all a small overall axial length, having a high degree of efficiency, and that at the same time may be manufactured more cost-effectively.

The invention is based upon the knowledge that by consistently displacing the gear sets to the lateral side of the transmission inlet a cost-effective dual clutch transmission with a very short overall axial length and an improved overall utilization of the installation space can be accomplished while retaining the conventional compact design of the dual clutch with transmission input shafts arranged coaxially in relation to each other.

Accordingly, the present invention departs from a dual clutch transmission, for example for a motor vehicle, having a dual clutch consisting to two start up clutches via which a prime mover can be respectively connected with one of two transmission input shafts arranged coaxially in relation to each other, each of the two transmission input shafts being allocated a group of gears.

In order to attain this object, the present invention moreover provides that the gear groups are constructed as sub-transmissions mounted at the side of the dual clutch, which respectively have a countershaft and a main shaft constructed as a transmission output shaft, where each sub-transmission may be driven via exactly one sub-transmission connection operating between the associated transmission input shaft and the countershaft of the sub-transmission.

This arrangement has the advantage that in any given case only one gearing is mounted on both transmission input shafts. Otherwise, no further transmission drive elements are necessary on the transmission input shafts. The transmission input shafts can consequently be shortened in their total length in comparison to other dual clutch transmissions. Moreover, the advantageous concept of dual clutches interconnected with each other with an outer hollow shaft on the output side and an inner solid shaft remains preserved. Since, moreover, due to the consistent displacement of both sub-transmissions away from the transmission input shafts, the complete overall constructive depth of the dual clutch may be used on both sides of the dual clutch as well as an axial installation space for the gear groups, an advantageous dual clutch transmission with a very effective utilization of the installation space, for example for front, crosswise installation in a motor vehicle, is made possible by the present invention.

The drive of the sub-transmissions via the transmission input shaft may be realized in a particularly simple manner in that the sub-transmission connections between the transmission input shafts and the sub-transmission are respectively constructed as an idler which meshes with a single fixed wheel arranged on the transmission input shaft on the drive side and on the output side with a fixed wheel arranged on the output side.

The flow of forces, via the dual clutch transmission for driving the motor vehicle between the crankshaft of an internal combustion motor and the motor vehicle to be driven, runs in each forward gear, starting at the crankshaft and an optional torsional vibration damper via the clutch of the dual clutch allocated to the corresponding gear toward the corresponding transmission input shaft constructed as a drive shaft. This is preferably the outer transmission input shaft constructed as a hollow shaft in the even gears, and the inner transmission input shaft constructed as a central or solid shaft in the odd gears. From there, the flow of forces runs via the sub-transmission connection according to the present invention, namely via a fixed wheel of the transmission input shaft to an idler, which meshes with a further fixed wheel on the countershaft. The flow of forces runs from the respective countershaft either via the fixed wheel to a loose wheel meshing with it, or via a clutch mechanism (synchronization or claw clutch) toward the main shaft of the sub-transmission, or via a clutch mechanism mounted on a countershaft toward another loose wheel and further onto a fixed wheel meshing with it on the main shaft of this sub-transmission. From the main shaft it subsequently runs via a fixed wheel toward a usual fixed wheel of the differential and after the differential to the left and right output shaft toward the motor vehicle wheels.

In order to keep the installation space requirement and the weight as well as the manufacturing costs of the transmission as small as possible, it is furthermore advantageous to minimize the number of necessary gear wheels for realizing a projected number of gears. This is in particular effectively realized in the arrangement according to the present invention via the double or multiple utilization of the various gear wheels.

In particular for this purpose it can be provided that in at least one of the two sub-transmissions, the fixed wheel of the countershaft meshing with the fixed wheel at the same time actuates as a gear fixed wheel of a forward gear via which a loose gear wheel of the gear arranged on the associated main shaft can be driven. Basically, the idlers may, however, also drive additional fixed gearings of the countershaft.

It can furthermore be provided that in one of the two sub-transmissions the fixed wheel of the countershaft, which meshes with the idler, at the same time actuates as a fixed gearwheel of a reverse gear via which a loose gearwheel of the reverse gear, which is arranged on the associated main shaft, can be driven, a reverse gear-idler being arranged pivoted between the fixed gear wheel and the loose gearwheel. Basically the reverse loose gearwheel may also be driven in one step directly by the idler of the sub-transmission connection.

It may also be provided that, in at least one of the two sub-transmissions, a fixed gear wheel mounted on the main shaft, which meshes with at least one loose gear wheel mounted on the countershaft, at the same time actuates as an output wheel via which the fixed wheel of the differential can be respectively driven.

A further reduction in the overall space requirement can be accomplished in that the output wheels mounted on the main shafts for the sequential drive of the differential, via both sub-transmissions, are arranged on a common output level of the main shafts.

The arrangement according to the present invention is especially advantageously suitable for the construction of dual clutch transmissions with six or seven forward gears. In this connection, a particularly compact design may be achieved in that the gear sets are distributed on the sub-transmissions as evenly as possible, the reverse gear being preferably allocated to the sub-transmission with the even gears so that, with a six-gear transmission as well as with a seven-gear transmission, gears two, four, six as well as the reverse gear are arranged on the one transmission side, and gears one, three, five and, if necessary, seven are arranged on the other transmission side.

In this connection, it is advantageous that the sub-transmission with the even gears may be driven via the transmission input shaft constructed as an outer hollow wheel, while the sub-transmission with the odd gears may be driven via the transmission input shaft constructed as an inner solid shaft, so that the reverse gear may constantly be connected with the hollow shaft and the first gear with the solid shaft. The fixed gear wheels of the reverse gear and the first gear are preferably arranged on the countershaft and the associated loose gear wheels are arranged on the main shaft.

Finally, it is also useful to keep the number of usual synchronizing elements (friction elements) and/or claw clutches for shifting the individual gears as low as possible or to use them as effectively as possible. For this purpose, two gears can respectively be acted upon by a joint synchronizer according to the number of gears of the transmission, whereby suitable combinations are formed according to the arrangement of the gear sets. Correspondingly, four synchronizing packages are necessary with a six- or seven-gear transmission, whereby with the six-gear version, one side of the synchronizing package remains vacant.

### BRIEF DESCRIPTION OF THE DRAWINGS

A drawing of an exemplary embodiment is attached to the description for the purpose of clarification of the present invention, wherein:

FIG. 1 shows a schematic representation of a six-gear dual clutch transmission,

FIG. 2 illustrates a second embodiment of a six-gear dual clutch transmission,

FIG. 3 shows a schematic representation of a seven-gear dual clutch transmission,

FIG. 4 shows a schematic side view of a first shaft arrangement of a dual clutch transmission and

FIG. 5 shows a schematic side view of a dual clutch transmission with a second shaft arrangement,

### DETAILED DESCRIPTION OF THE PREFERRED EMBODIMENTS

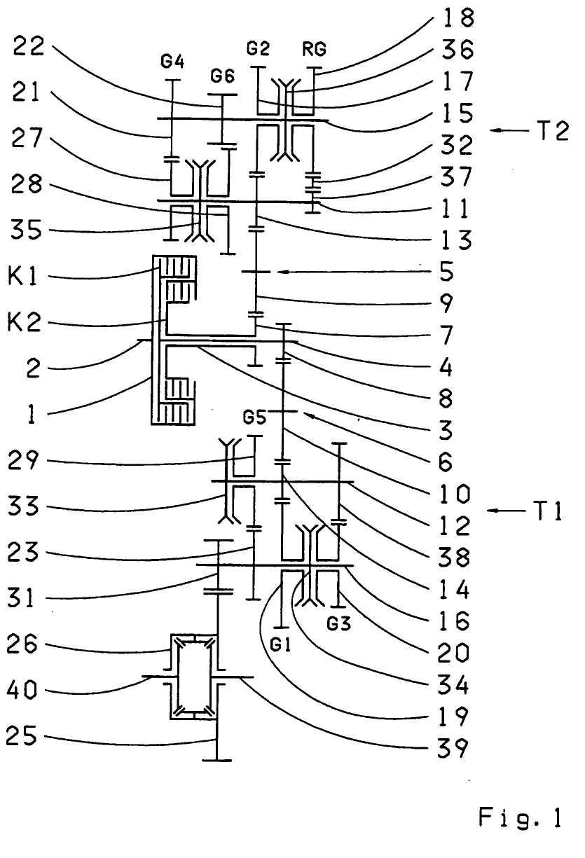

Accordingly, a transmission scheme of a six-gear dual clutch transmission for front, crosswise installation in a motor vehicle is represented in FIG. 1. In this drawing, a dual clutch 1 consisting of two start up clutches K1, K2 which are connected with a crankshaft 2 of an internal combustion motor (not represented) either directly or, for vibration damping, advantageously via a torsional vibration damper or a two-mass flywheel, drives two coaxial transmission input shafts 3 and 4 corresponding to a sequential control unit of the two clutches K1 and K2. Here the input shaft 4 constructed as an inner, solid shaft drives a group of odd gears G1, G3, G5, and the transmission input shaft 3 constructed as an outer hollow shaft drives a group of even gears G2, G4, G6 as well as a reverse gear RG. The reverse gear RG is always advantageously allocated to the group of even gears G2, G4, G6 and may be driven by the hollow shaft 3. The two gear groups G1/G3/G5 and/or G2/G4/G6/RG respectively form a sub-transmission T1 and/or T2 which is connected with the associated transmission input shaft 3, 4 via a sub-transmission connection 5, 6.

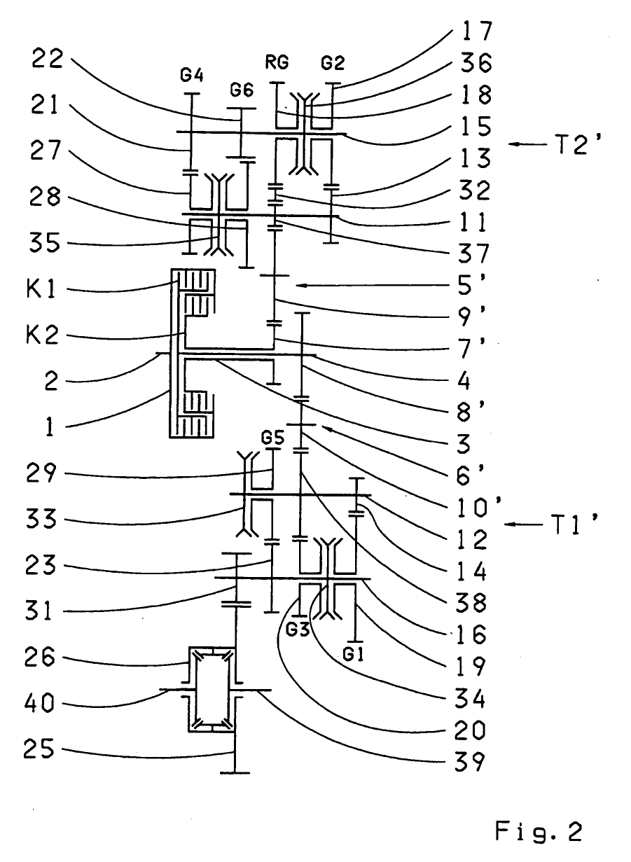

FIGS. 1 and 2 show two variants of the dual clutch transmission with the two sub-transmissions T1 and T2 and/or with the sub-transmissions T1′ and T2′ modified in their gear set arrangement. The sub-transmissions T1, T1′, T2, T2′ are respectively allocated two synchronizers 33, 34, 35, 36 in pairs for synchronizing and shifting the individual gears. In this connection, the first gear and the third gear G1+G3, the second gear and the reverse gear G2+RG as well as the fourth gear and the sixth gear G4+G6 are preferably combined as synchronizing packages S(n/m), with n and m for the respective axially adjacent gear. Synchronizer 33 allocated to the fifth gear G5 is only unilaterally active.

In a not represented further six-gear variant, the third gear and the fifth gear G3+G5 may also be combined, the corresponding synchronizer 34 being then only unilaterally active on the first gear G1.

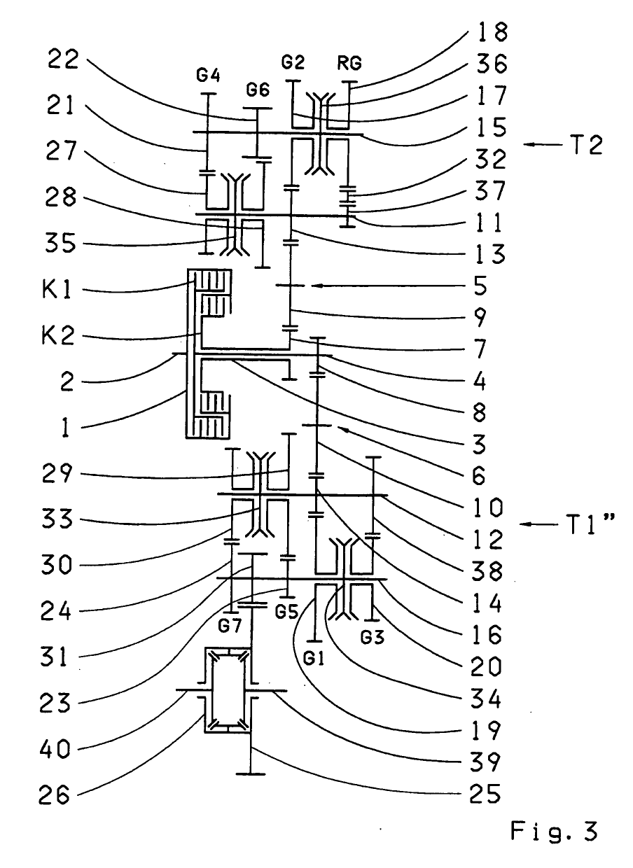

FIG. 3 illustrates a seven-gear dual clutch transmission with the even sub-transmission T2 and an odd sub-transmission T1″. In the seven-gear variant, all four synchronizers 33, 34, 35, 36 are completely occupied by the combination G5+G7 of the fifth gear G5 with the newly added seventh gear G7. Otherwise, the seven-gear variant corresponds to the six-gear variant of FIG. 1.

In FIGS. 1 and 2 the synchronizers 33, 34 and/or the synchronizing package S(n/m) and the gear sets G1, G3, G5 of the odd sub-transmission T1, T1′ of the six-gear transmission are arranged in the following sequence viewed from the (left) motor side:

Sub-transmission T1: S(−/5)—5th gear—1st gear—S(3/1)—3rd gear (FIG. 1), and/or Sub-transmission T1′: S(−/5)—5th gear—3rd gear—S(⅓)—1st gear (FIG. 2).

Alternatively, the following not illustrated sequences of element levels of the odd sub-transmission may be realized:

5^{th gear—S(}5/−)—1st gear—S(⅓)—3rd gear, or

5^{th} gear—S(5/−)—3rd gear—S( 3/1)—1st gear, or

5^{th} gear—S( 5/3)—3rd gear—S(−/1)—1st gear, or

3^{rd} gear—S(⅗)—5th gear—S(−/1)—1st gear, or

5^{th} gear—S(5/3)—3rd gear—1st gear—S(1/−), or

3^{rd} gear—S(⅗)—5th gear—1st gear—S(1/−).

In FIG. 3 with the seven-gear dual clutch elements, the synchronizers 33, 34 and/or gear sets G1, G3, G5, G7 of the odd sub-transmission T1″ are arranged in the following sequence, once again viewed from the left motor side:

Partial transmission T″: 7th gear—S(7/5)—5th gear—1st gear—S(⅓)—3rd gear.

Here the following (not represented) alternatives are possible:

5^{th} gear—S( 5/7)—7th gear—1st gear—S(⅓)—3rd gear, or

5^{th} gear—S( 5/7)—7th gear—3rd gear—S(3/1)—1st gear, or

7^{th} gear—S(7/5)—5th gear—3rd gear—S(3/1)—1st gear.

The following arrangements result for the element levels of the even sub-transmission T2, T2′:

Sub-transmission T2: 4^{th} gear—S(4/6)—6^{th} gear—2^{nd} gear—S(2/R)—reverse gear (FIG. 1+3), and/or

Sub-transmission T2′: 4^{th} gear—S(4/6)—6^{th} gear—reverse gear—S(R/2)—2^{nd} gear (FIG. 2),

or as (not represented) alternatives

Sub-transmission T2: 6^{th} gear—S(6/4)—4th gear—2nd gear—S(2/R)—reverse gear, or

Sub-transmission T2′: 6^{th} gear—S(6/4)—4th gear—reverse gear—S(R/2)—2nd gear.

To realize the mentioned sub-transmission connections 5, 5′, 6, 6′, only one gearing is mounted on the two transmission input shafts 3, 4 according to the present invention in each case, which is constructed as a fixed wheel 7, 7′ and/or 8, 8′. The fixed wheels 7, 7′, 8, 8′ respectively drive one transmission gearing shaft 11, 12 of the even and/or of the odd sub-transmission T2, T2′, T1, T1′, T1″ via respectively one idler 9, 9′, 10, 10′. A fixed wheel 13, 14, 37, 38 on the respective countershaft 11 and/or 12 in each case driven by the idler 9, 9′, 10, 10′ advantageously at the same time serves as a driving gear wheel for a loose gear wheel of any desired gear of the respective sub-transmission. In FIG. 1, these are the loose gearwheels 19 and/or 17 of the first and the second gear G1 and/or G2, while in FIG. 2 they are the loose gear wheels 20, 18 of the third gear G3 and the reverse gear RG. At the drive of the reverse loose gear wheel 18 via the fixed wheel 37 a further idler 32 is additionally interpolated drive-wise for inversion of the direction.

Furthermore, on the main shafts 15, 16 of the two sub-transmissions fixed wheels 21, 22, 23 for the fourth, fifth and sixth gear G4, G5, G6 are arranged, as well as in the case of a seven-gear dual clutch transmission, as shown in FIG. 3, a fixed wheel 24 of a seventh gear G7 is arranged. The fixed wheels 21 to 24 are taken into account for dual use according to the present invention, whereby the gearings may serve as a gear gearing of the mentioned gears G4-G7 with their loose gear wheels 27, 28, 29, 30 as well as an output gearing to a differential wheel 25 on a differential 26.

In the sub-transmissions T2, T2′ of FIGS. 1 to 3, the fixed wheel 22 of the sixth gear G6 functions as the differential output and transfers the output torque of the internal combustion motor to the differential wheel 25 (represented at the bottom in FIGS. 1 to 3), whereby, when the sixth gear G6 is engaged, the drive of the fixed wheel 22 takes place from the associated loose wheel 28 of the sixth gear G6 arranged on the main shaft 15 and in the other gears G2, G4, RG via the main shaft 15. Alternatively, the fixed wheel 21 of the fourth gear G4 may also be used as the output gear wheel in sub-transmissions T2, T2′ instead of the fixed wheel 22 of the sixth gear G6.

For the drive of the differential wheel 25 of the sub-transmission T1, T1′, T1″ at the bottom of FIGS. 1 to 3 an additional fixed wheel 31 is provided as an output wheel 16. The output wheel 31 of the first sub-transmission T1, T1′, T1″ and the output wheel 22 of the second sub-transmission T2, T2′ are advantageously arranged on a common transmission output level.

Basically, a series of marginal conditions are advantageous in the possible transmission variants which are considered in the Figures and are again outlined below for clarification:

In the gear set G1 of the first gear, the fixed wheel 14 is preferably arranged on the countershaft 12 and the loose wheel 19 on the main shaft 16.

In the gear set G3 of the third gear, the fixed wheel 38 and/or the loose wheel 20 may be arranged on the countershaft 12 and/or the main shaft 16 depending on the connection to the relevant synchronizer 33 and/or 34. In the case of the synchronizing package S(⅓), however, the fixed wheel 38 is preferably arranged on the countershaft 12 and the loose wheel 20 on the main shaft 16.

In the gear sets G5 and G7 of the fifth gear and of the seventh gear, the loose wheels 29, 30 are preferably arranged on the countershaft 12 and the fixed wheels 23, 24 on the main shaft 16.

In the gear sets G2 and RG of the second gear and of the reverse gear, the fixed wheels 13, 37 are preferably arranged on the countershaft 11 and the loose wheels 17, 18 on the main shaft 15.

In the gear sets G4 and G6 of the fourth gear and the sixth gear, the loose wheels 27, 28 are preferably arranged on the countershaft 11 and the fixed wheels 21, 22 on the main shaft 15.

The differential wheel 25 may be driven from the odd sub-transmissions T1, T1′, T1″, preferably by an existing fixed gearing 23, 24 of the gears five and seven G5, G7 on the main shaft 16 or of gear G3 in the event its fixed gearing 38 is arranged on the main shaft 16, or alternatively by an arbitrarily positionable additional fixed gearing 31 of the main shaft 16.

The differential wheel 25 may be driven by the even sub-transmission T2, T2′, preferably by an existing fixed gearing 21 and/or 22 of gears G4 or G6 on the main shaft, or alternatively by an additional fixed gearing which can be arbitrarily positioned on the main shaft 15.

The fixed wheels of the two sub-transmissions T1, T1′, T1″, T2, T2′ functioning as output gearings in relation to the differential transmission are preferably arranged on a common transmission level.

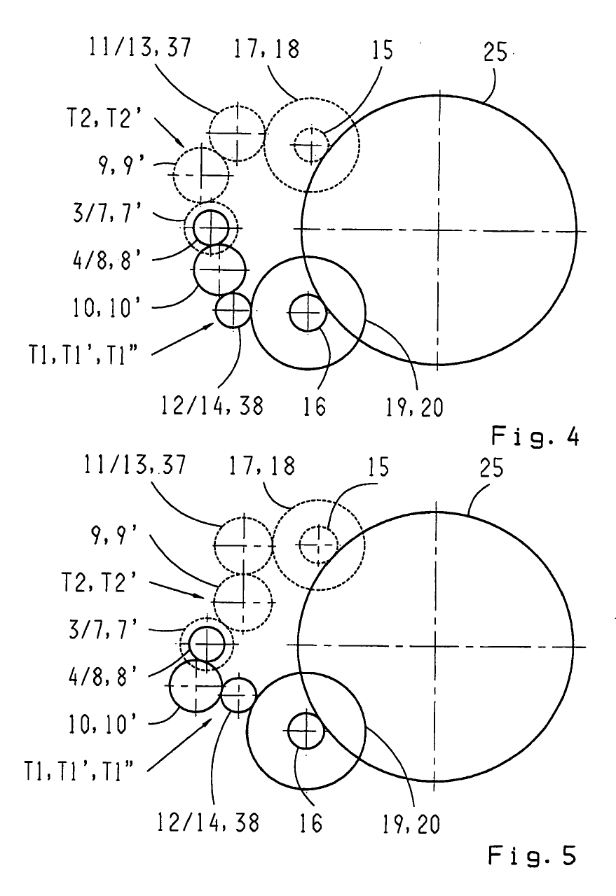

FIGS. 1 to 3 show an unfolded view of the dual clutch transmission. For clarification of the lateral displacement of the sub-transmissions T1, T1′, T1″, T2, T2′ as well as of the operative connections of the shafts involved, FIGS. 4 and 5 show a side view of the dual clutch transmission. Both illustrations show two possible arrangements of the transmission shafts, whereby it can be recognized that the individual components are largely distributed in the lateral direction, namely in the radial direction away from the transmission input shafts 3 and 4, and not positioned consecutively in the axial direction on the axis of the two coaxial transmission input shafts, as in the vast majority of conventional dual clutch transmissions.

The operating mode of a dual clutch transmission has been inherently known. Moreover, the individual gears are sequentially interconnected, whereby the gear following the gear currently engaged in one sub-transmission is respectively preselected in the other sub-transmission, and the gear change takes place by overlapping the disengagement and engagement stage of both clutches largely free from tractive force interruptions.

Thus, only the flow of forces of the dual clutch transmission according to the present invention of FIG. 1 to 3 in a forward gear will be looked into in more detail:

A motor torque of the internal combustion motor is transferred from crankshaft 2 via the dual clutch 1 and the clutch K1 and/or K2 allocated to the engaged gear to the corresponding transmission input shaft 3 and/or 4. The fixed wheel 7, 7′, 8, 8′ of the input shaft 3, 4 drives an idler 9, 9′, 10, 10′ which engages into a further fixed wheel 13, 14, 38 on the countershaft 11 or 12. The torque of the countershaft 11, 12 is transferred either via the fixed wheel 13, 14, 38 to a loose wheel 17,19, 20 meshing with it, and via the associated synchronizer 34, 36 to the main shaft 15,16, or via a synchronizer 33, 35 mounted on the countershaft 11, 12 to a loose wheel 27, 28, 29, 30 and to a fixed wheel 21, 22, 23, 24 meshing with it to the main shaft 15, 16. The output torque of the main shaft 15, 16 is transferred via the fixed wheel 21, 22, 23, 24 or an additional fixed wheel 31 mounted on the main shaft 11, 12 to the fixed wheel 25 of the differential 26 and finally after the differential 26 to the left and right output shafts 39, 40 to the motor vehicle wheels to be driven.

### REFERENCE NUMERALS

1 Dual clutch
2 Crankshaft
3 Transmission input shaft for sub-transmission T2, T2′
4 Transmission input shaft for sub-transmission T1, T1′, T1″
5, 5′ Sub-transmission connection for sub-transmission T2, T2′
6, 6′ Sub-transmission connection for sub-transmission T1, T1′, T1″
7, 7′ Fixed wheel on transmission input shaft 3
8, 8′ Fixed wheel on transmission input shaft 4
9, 9′ Idler for sub-transmission T2, T2′
10, 10′ Idler for sub-transmission T1, T1′, T1″
11 Countershaft for sub-transmission T2, T2′
12 Countershaft for sub-transmission T1, T1′, T1″
13 Fixed wheel on countershaft 11
14 Fixed wheel on countershaft 12
15 Main shaft for sub-transmission T2, T2′
16 Main shaft for sub-transmission T1, T1′, T1″
17 Loose wheel, 2^{nd} gear
18 Loose wheel, reverse gear
19 Loose wheel, 1^{st} gear
20 Loose wheel, 3^{rd} gear
21 Fixed wheel, 4^{th} gear
22 Fixed wheel, 6^{th} gear
23 Fixed wheel, 5^{th} gear
24 Fixed wheel, 7^{th} gear
25 Differential fixed wheel
26 Differential
27 Loose wheel, 4^{th} gear
28 Loose wheel, 6^{th} gear
29 Loose wheel, 5^{th} gear
30 Loose wheel, 7^{th} gear
31 Fixed wheel for differential wheel output
32 Idler for reverse gear
33 Synchronizer
34 Synchronizer
35 Synchronizer
36 Synchronizer
37 Fixed wheel, reverse gear
38 Fixed wheel, 3^{rd} gear
39 Output shaft for left motor vehicle wheel
40 Output shaft for right motor vehicle wheel
G1 Gear set for 1^{st} gear
G2 Gear set for 2^{nd} gear
G3 Gear set for 3^{rd} gear
G4 Gear set for 4^{th} gear
G5 Gear set for 5^{th} gear
G6 Gear set for 6^{th} gear
G7 Gear set for 7^{th} gear
K1 Start up clutch for sub-transmission T1, T1′, T1″
K2 Start up clutch for sub-transmission T2, T2′ RG Reverse gear
S(n/m) Synchronization package, n, m=1, . . . , 7, R
T1 Odd sub-transmission
T1′, T1″ Odd sub-transmission
T2, T2′ Even sub-transmission

1-10. (canceled)

11. A dual clutch transmission having a dual clutch (1) comprising two start up clutches (K1, K2) which, via a prime mover, is respectively connected with one of first and second transmission input shafts (3, 4) arranged coaxially in relation to each other, at least one gear group (G1, G2, G3, G4, G5, G6, G7, RG) being allocated to each of the first and the second transmission input shafts (3, 4), the gear groups (G1, G2, G3, G4, G5, G6, G7, RG) being constructed as a sub-transmission (T1, T1′, T1″, T2, T2′) mounted to a side of the dual clutch (1) and each respectively having a countershaft (11, 12) and a main shaft (15, 16), which is a transmission output shaft, and each of the sub-transmission (T1, T1′, T1″, T2, T2′) being driven by only one sub-transmission connection (5, 5′, 6, 6′) operating between the associated first and second transmission input shaft (3, 4) and the respective countershaft (11, 12) of the sub-transmission (T1, T1′, T1″, T2, T2′).

12. The dual clutch transmission according to claim 11, wherein the sub-transmission connections (5, 5′, 6, 6′) are comprise an idler gear (9, 9′, 10,10′) located between the respective first and the second transmission input shafts (3, 4) and the sub-transmissions (T1, T1′, T1″, T2, T2′), and a drive side the respective idler gear (9, 9′, 10,10′) meshes with a fixed wheel (7, 7′, 8′, 8″) arranged on one of the first and the second transmission input shaft (3, 4) and an output side the respective idler gear (9, 9′, 10, 10′) meshes with a fixed wheel (13, 14, 37, 38) arranged on the countershaft (11, 12).

13. The dual clutch according to claim 12, wherein the fixed wheel (13, 14, 38) of the countershaft (11, 12), in at least one of the sub-transmissions (T1, T1′, T1″, T2, T2′) that meshes with the idler gear (9, 9′, 10, 10′), also act as a gear fixed wheel of a forward gear (G1, G2, G3), via which a gear loose wheel (17, 19, 20) of the forward gear (G1, G2, G3) arranged on the associated main shaft (15, 16), is driven.

14. The dual clutch transmission according to claim 12, wherein in at least one of the sub-transmissions (T2′), the fixed wheel (37) of the countershaft (11) which meshes with the idler gear (9′) also act as a gear fixed wheel of a reverse gear (RG), via which a gear loose wheel (18) arranged on the associated main shaft (15) is driven, whereby the reverse fixed gear wheel (37) and the loose gear wheel (18) mesh with a reverse idler gear (32).

15. The dual clutch transmission according to claim 11, wherein the two main shafts (15, 16) respectively have an output wheel (22, 31) arranged on a common output level of the main shaft (15, 16), via which a differential fixed wheel (25) of a differential (26) is respectively driven.

16. The dual clutch transmission according to claim 15, wherein in at least one of the sub-transmissions (T2, T2′), a fixed gear wheel (22) mounted on the main shaft (15, 16), which meshes with a gear loose wheel (28) mounted on the countershaft (11, 12), acts as an output wheel.

17. The dual clutch transmission according to claim 11, wherein in one of the sub-transmissions (T2, T2′) drives at least three even forward gears (G2, G4, G6) and a reverse gear (RG), and the other of the sub-transmissions (T1, T1′, T1″) drives at least three odd forward gears (G1, G3, G5).

18. The dual clutch transmission according to claim 17, wherein the first transmission input shaft (3) is an external hollow shaft which drives the sub-transmission (T2, T2′) for the at least three even forward gears (G2, G4, G6) and the reverse gear (RG), and the second transmission input shafts (4) is an inner, solid shaft which drives the other of the sub-transmissions (T1, T1′, T1″) for the at least three odd forward gears (G1, G3, G5).

19. The dual clutch transmission according to claim 12, wherein the fixed gear wheel (14) of a first gear (G1) is arranged on the countershaft (12) of the sub-transmission (T1, T1′, T1″) which is driven by the second transmission input shaft (4) which is an inner shaft.

20. The dual clutch transmission according to claim 11, wherein corresponding to a provided number of gears, two gears are respectively allocate a common synchronizer (33, 34, 35, 36).

21. A dual clutch transmission comprising:
a first clutch (K1) being coupled to and driving a first transmission input shaft (4), and a second clutch (K2) being coupled to and driving a second transmission input shaft (3), the first clutch (K1) and the first transmission input shaft (4) being coaxially aligned with the second clutch (K2) and the second transmission input shaft (3), the second transmission input shaft (3) being hollow and having a gear (7) fixed thereto, and the first transmission input shaft (4) coaxially extending within the second transmission input shaft (3) and having a gear (8) fixed thereto;
a first sub-transmission (T1) including a main shaft (16) and a countershaft (12) which has at least one gear (14) fixed thereto;
a second sub-transmission (T2) including a main shaft (15) and a countershaft (11) which has at least one gear (13) fixed thereto;
a first idler gear (10) solely transmitting drive from the gear (8) fixed to the first transmission input shaft (4) to the at least one gear (14) fixed to the countershaft (12) of the first sub-transmission (T1); and
a second idler gear (9) solely transmitting drive from the gear (7) fixed to the second transmission input shaft (3) to the at least one gear (13) fixed to the countershaft (11) of the second sub-transmission (T2).

22. The dual clutch transmission according to claim 21, wherein the main shaft (15) of the second sub-transmission (T2) has a fixed output gear (22) that engages and drives a fixed gear (25) of a differential (26) and the main shaft (16) of the first sub-transmission (T1) has a fixed output gear (31) that engages and drives the fixed gear (25) of the differential (26).
